(19) United States
(12) Patent Application Publication
(10) Pub. No.: US 2002/0092671 A1
(43) Pub. Date: Jul. 18, 2002

(54) Strain relief for electrical cord

(75) Inventor: Paul D. Stephens, Twinsburg, OH (US)

Correspondence Address: Jay F. Moldovanyi, Esq., Fay, Sharpe, Fagan, Minnich & McKee, LLP, 7th Floor, 1100 Superior Avenue, Cleveland, OH, 44114-2518, US

(73) Assignee: Royal Appliance Mfg. Co.

(21) Appl. No.: 09/759,826

(22) Filed: Jan. 12, 2001

(51) Int. Cl. H01B 7/00

(52) U.S. Cl. 174/135

(57) ABSTRACT

A handle arrangement for an ambulatory electrical machine is provided. The handle arrangement includes a housing adapted for movement on a surface. A handle is connected to the housing. The handle includes a casing defining a cavity therein. A switch is mounted on the handle. An electrical cord extends through the cavity and attaches at one end to the switch. A strain relief member is mounted in the cavity. The strain relief member includes a sinuous channel defined therein for accommodating the electrical cord.

### BACKGROUND OF THE INVENTION

The present invention relates to vacuum cleaners. More particularly, the invention relates to a strain relief member for an electrical cord in a vacuum cleaner and will be described with particular reference thereto. However, it is to be appreciated that the present invention may also be amenable for other applications.

In vacuum cleaners, there is a need for a device that alleviates strain in an electrical cord running through a vacuum cleaner body and connecting to a component thereof. More particularly, cords and/or wires are often used within vacuum cleaners to electrically connect a power source to a switch, light, control, or the like. These cords and/or wires are susceptible to disconnecting from the switch, light, control, or the like due to a strain placed on a particular cord and/or wire connected thereto, especially when the vacuum cleaner is being assembled. Thus, there is a need for a device that prevents or reduces the effects of strains on cords and/or wires in vacuum cleaners.

The present invention provides a new and improved strain relief member for an electrical cord in a vacuum cleaner for overcoming the above-reference drawbacks and others.

### Summary of the Invention

In accordance with the present invention, a handle arrangement for an ambulatory electrical machine is provided.

More particularly in accordance with this aspect of the invention, the handle arrangement comprises a housing adapted for movement on a surface and a handle connected to the housing. The handle comprises a casing defining a cavity therein. A switch is mounted on the handle. An electrical cord extends through the cavity and is attached at one end to the switch. A strain relief member is mounted in the cavity. The strain relief member comprises a sinuous channel defined therein for accommodating the electrical cord.

According to another aspect of the present invention, a new and improved vacuum cleaner is provided.

More particularly in accordance with this aspect of the invention, the vacuum cleaner comprises a housing section including a handle. The handle has an electrical switch positioned thereon and an electrical cord attached at one end to the switch. A nozzle base section is interconnected with the housing section. The nozzle base section includes a main suction opening formed in an underside thereof. A filter chamber is defined in one of the housing section and the nozzle base section for separating dust and dirt from a suction airstream. A suction source, located in one of the housing section and the nozzle base section, is in fluid communication with the main suction opening. A strain relief member is received in an opening of the handle for minimizing strain on the electrical cord.

According to still another aspect of the invention, a new and improved vacuum cleaner is provided.

More particularly in accordance with this aspect of the invention, the vacuum cleaner comprises a nozzle section, a housing section connected to the nozzle section and in fluid communication with the nozzle section, and a filter chamber located in one of the housing section and the nozzle section for separating dirt and dust from a suction airstream. A handle is connected to the housing section. The handle comprises a casing and an opening defined within the casing. A switch is located on the handle casing. An electrical cord is connected at one end to the switch and runs through the casing opening. A strain relief member is positioned within the casing opening for alleviating strain on the electrical cord. The strain relief member comprises a sinuous channel through which the electrical cord extends.

### BRIEF DESCRIPTION OF THE DRAWINGS

The invention may take physical form in certain parts and arrangements of parts, a preferred embodiment of which will be described in detail in this specification and illustrated in the accompanying drawings which form a part hereof and wherein:

FIG. 1 is a perspective view of a vacuum cleaner which accommodates a strain relief member according to the present invention in a handle portion thereof;

FIG. 2 is an elevational perspective view of the handle portion of FIG. 1;

FIG. 3 is an exploded perspective view of the handle portion of FIG. 2 showing the strain relief member;

FIG. 4 is an enlarged top plan view of the strain relief member of FIG. 3;

FIG. 5 is an enlarged elevational perspective view of the strain relief member of FIG. 3;

FIG. 6 is a cross sectional view of the handle portion taken along lines 6-6 of FIG. 2 showing the strain relief member positioned in the handle portion and engaging a cord in the handle portion;

FIG. 7 is a front elevational view of the handle portion of FIG. 1;

FIG. 8 is a cross sectional view of the handle portion taken along lines 8-8 of FIG. 7; and

FIG. 9 is a cross sectional view of a connection between the handle portion and a housing of the vacuum cleaner taken along lines 9-9 of FIG. 1.

### DETAILED DESCRIPTION OF THE PREFERRED EMBODIMENT

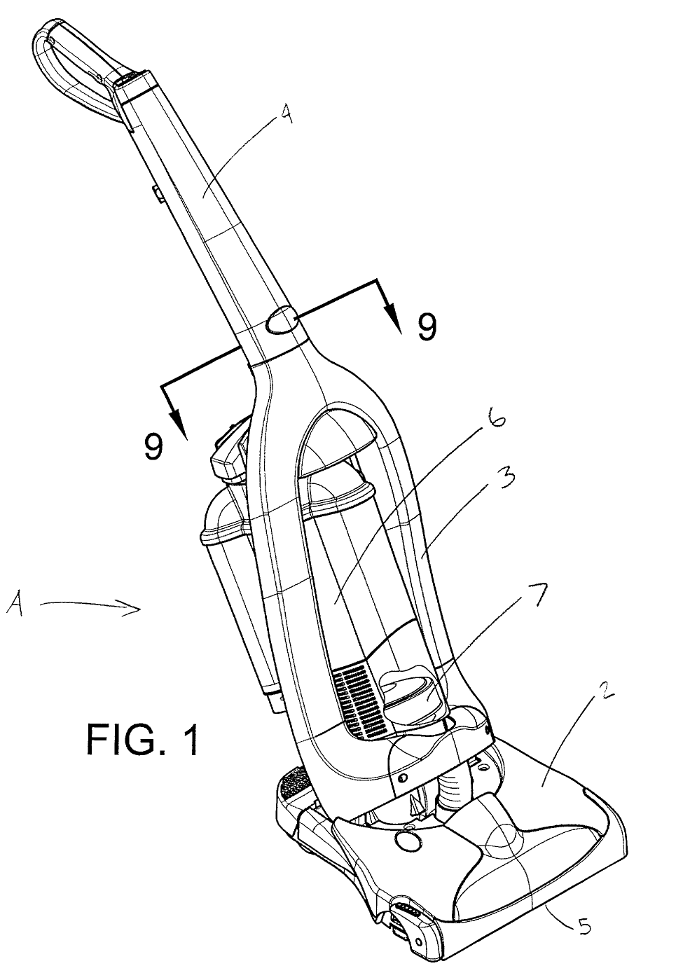

Referring now to the drawings wherein the showings are for purposes of illustrating the preferred embodiment of the invention only and not for purposes of limiting the same, FIG. 1 shows a vacuum cleaner A comprising a base portion 2 and a housing 3 having a handle portion 4. The base portion 2 comprises a main suction opening 5 formed in an underside thereof. The housing 3 comprises a filter chamber 6 for separating dust and dirt from a suction air stream and a suction source 7 in fluid communication with the main suction opening 5. While the vacuum cleaner A is illustrated as being of an upright type, it should be appreciated by those of average skill in the art that the present invention described and illustrated herein could also be employed for use on canister vacuum cleaners, wet/dry vacuums and in a variety of other fluid supply or fluid withdrawal environments.

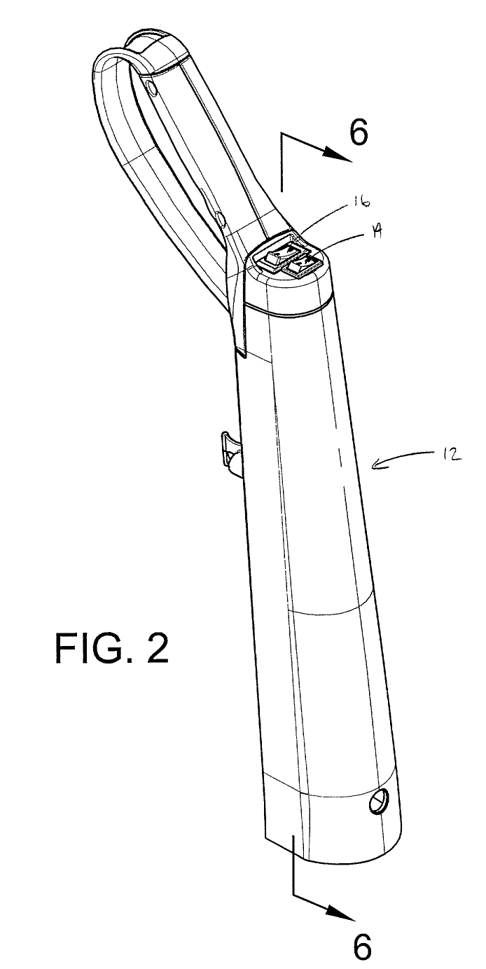

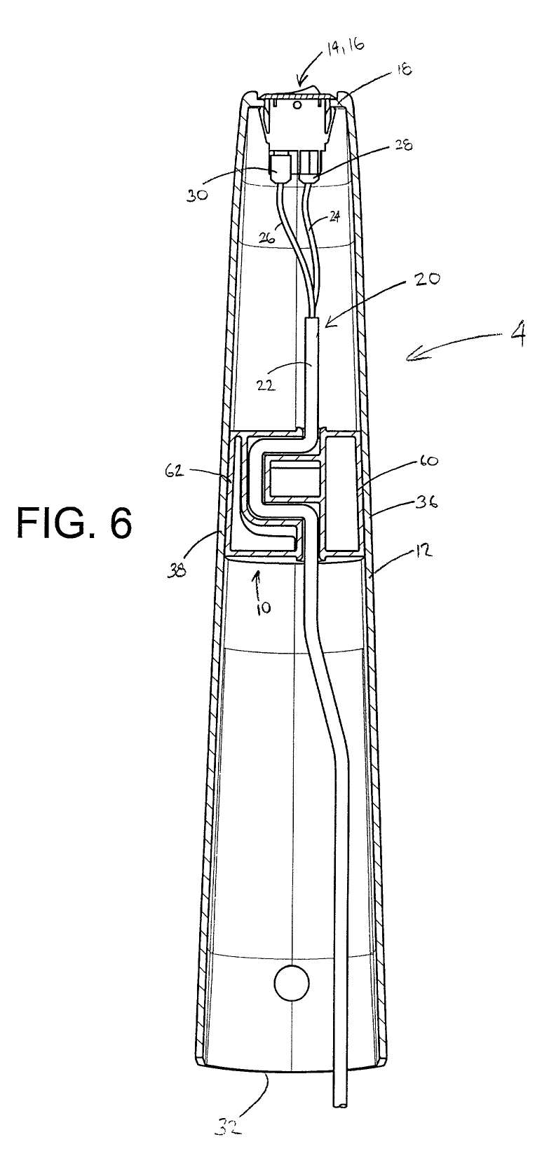

With reference now to FIG. 6, the handle portion 4 comprises a strain relief member 10 positioned within a generally hollow shell 12 of the handle portion 4. A pair of switches 14,16 (FIG. 2) are positioned on a first closed end 18 of the shell 12. A cord 20 is operatively connected at one end to the switches 14,16.

The cord comprises an insulating tubular sheath 22 and a pair of electrical wires 24,26. The wires 24,26 pass through the tubular sheath 22 and each terminate at one end into electrical connectors 28,30 which are operatively connected to the switches 14,16. The cord 20 extends through the shell 12, engaging the strain relief member 10 and passing through a second open end 32 of the shell 12. The strain relief member 10 functions to minimize the strain on the cord 20.

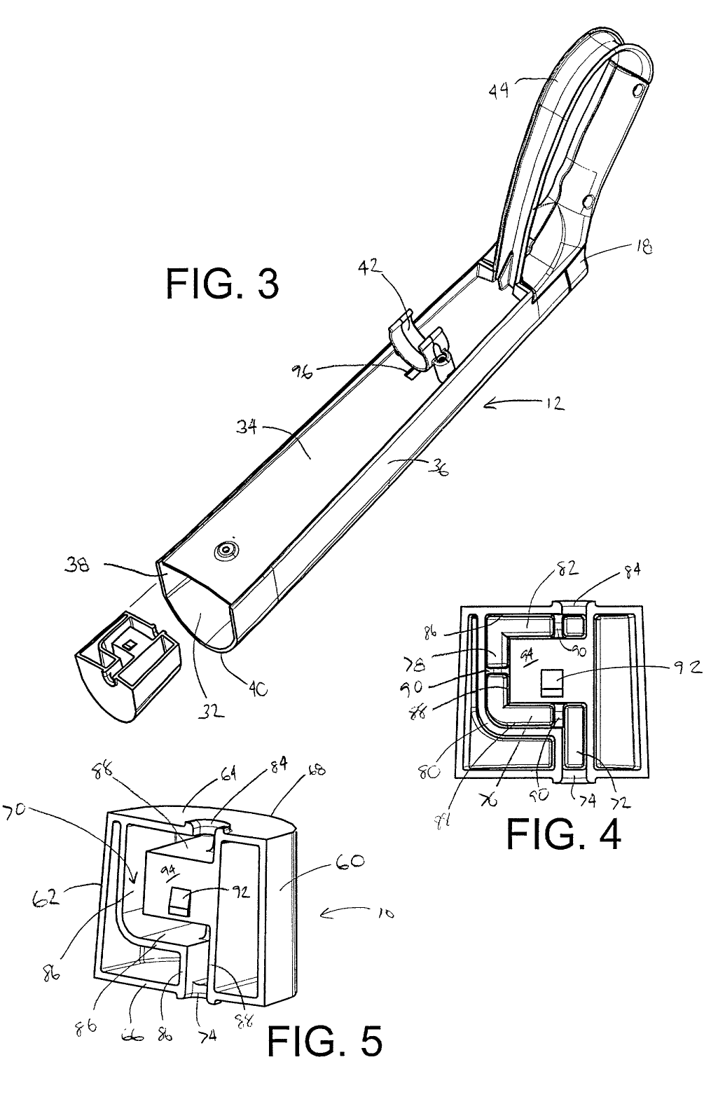

With reference now to FIG. 3, the shell 12 comprises a substantially planar rear wall 34 extending between the open end 32 and the closed end 18. A pair of opposing edges of the rear wall 34 taper inwardly toward one another from the open end 32 to the closed end 18. A pair of side walls 36,38 also extends between the open end 32 and the closed end 18. The side walls 36,38 are each connected along a first edge to the rear wall 34. The side walls 36,38 taper inwardly toward one another from the open end 32 to the closed end 18. Connected to a second edge of each side wall 36,38, a curved front wall 40 extends between the first open end 32 and the closed end 18. The curved wall 40 generally tapers inwardly from the open end 32 to the closed end 18.

A C-clip fastener 42 is disposed along the rear wall 34 at or near an intermediate portion of the rear wall 34. The fastener 42 is adapted to receive a tubular vacuum tool or wand (not illustrated). Of course, it is to be appreciated that any other type of fastener could be similarly used and all such fasteners are to be considered within the scope of the present invention.

A hand grip 44 is connected to the closed end 18 of the shell 12. The hand grip 44 is of a loop-type and extends outwardly from the shell 12 in a direction generally between the rear wall 34 and the closed end 18. The hand grip 44 is adapted for manipulation to control the vacuum cleaner A during use or operation thereof.

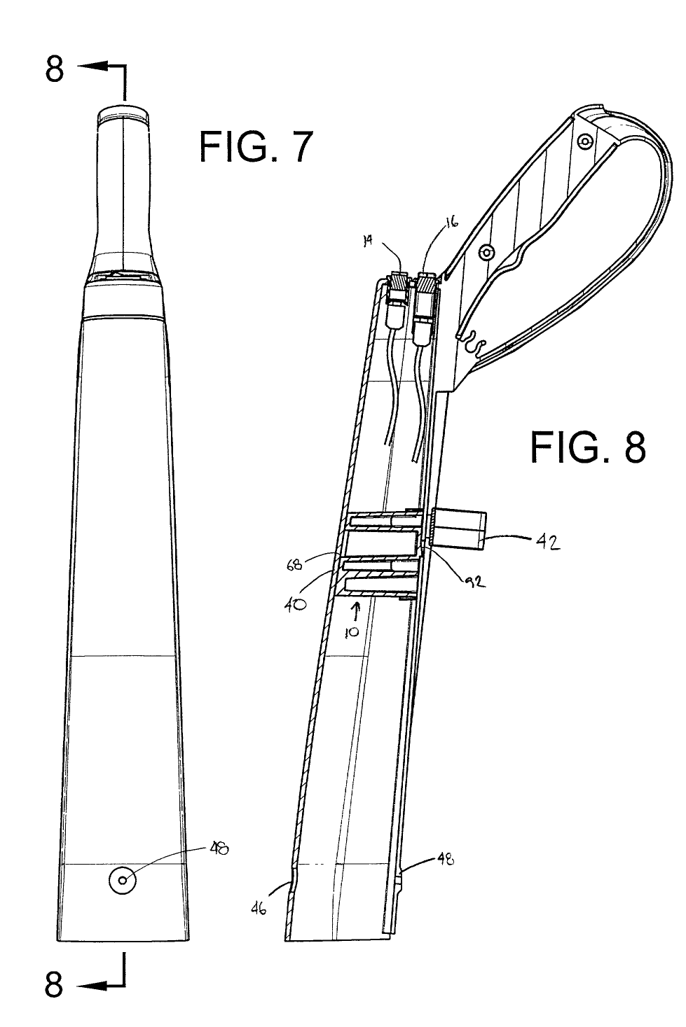

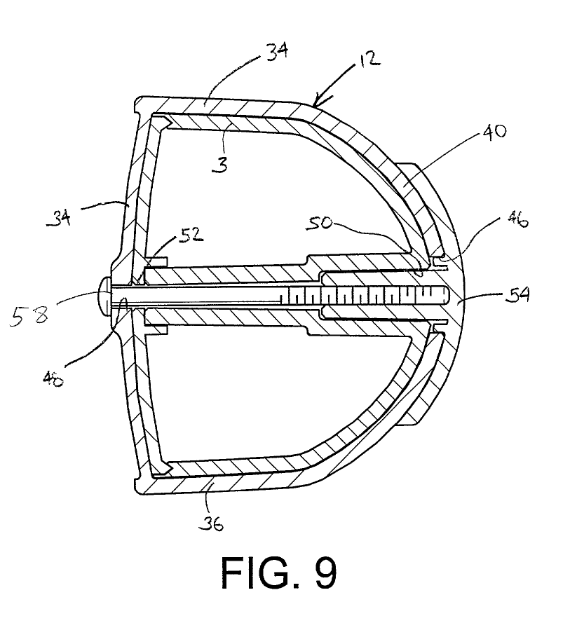

With additional reference to FIG. 9, the shell 12 also includes a connecting means located near the open end 32 thereof. The connecting means allows the handle portion 4 to be connected to the housing 3 of the vacuum cleaner A. The connecting means illustrated includes an open front recess 46 (FIG. 2) in the curved wall 40 of the shell 12 and a reinforced bolt recess 48 formed in the rear wall 34 (FIG. 7). The housing 3 includes a corresponding front recess 50 and a corresponding bolt recess 52. The housing 3 also includes a bolt housing and coverplate structure 54 extending between the recesses 52,54.

To connect, the respective recesses 46-52 are aligned and a bolt 58 is then inserted into the bolt recesses 48,52 and threaded into the housing structure 54. Of course, the connection between the handle portion 4 and the housing 3 may be accomplished by any other suitable connection means.

With reference to FIG. 5, the strain relief member 10 comprises side walls 60,62, end walls 64,66, and a curved front wall 68. A sinuous channel 70 is defined within an open rear face of the relief member 10. The open rear face is located in a plane approximately perpendicular to the generally flat ends of the walls 60-66.

More particularly, the sinuous channel 70 extends between and passes through the end walls 64,66. With additional reference to FIG. 4, the sinuous channel 70 comprises a first section 72 extending from a first recess 74 in the end wall 66 into the relief member 10. A second section 76 is connected to the first section 72 and extends therefrom at an angle of approximately ninety degrees relative to the first section 72. A third section 78 is connected to the second section 76 and extends further into the relief member 10 in a direction parallel to the first section 72. A curved radius 80 connects the second section 76 to the third section 78. A fourth section 82 is connected to the third section 78 and connects to a second recess 84 in the end wall 64. The fourth section 82 runs in a direction parallel to the second section 76, and the second recess 84 is oriented approximately perpendicular to the axis of the fourth section.

The sinuous channel 70 is formed between opposing walls 86 and 88 defined in the relief member 10. More particularly, the walls 86 and 88 extend from the curved wall 40 to the open face of the relief member 10 defining a channel 70 through the relief member 10. The functional depth of the sinuous channel 70 is limited by the recesses 66,84 in the end walls 64,66 and a plurality of cord supports 90, best seen in FIG. 4 positioned in the channel. The cord supports 90 can be somewhat U-shaped in cross section to accommodate the cord 20.

The cord supports 90 are positioned with the sinuous channel 70 and between the walls 86,88. The cord supports 90 extend upward from the curved wall 68 in the same direction as the walls 86,88 extend. However, the cord supports 90 extend upward a distance less than the distance of the walls 86 and 88. In this manner, the functional depth of the channel 70 is gauged to be appropriate to accommodate the cord 20.

The side walls 60,62 of the relief member 10 taper inwardly toward one another at an angle substantially similar to taper of the side walls 36,38 of the shell 12. The curved wall 68 also tapers slightly inwardly from the end wall 66 to the end wall 64 (FIG. 8). The taper of the curved wall 68 is substantially similar to the taper of the curved wall 40 of the shell 12 at the intermediate portion thereof.

The strain relief member 10 includes a tab 92 located on a tab surface 94. The tab surface 94 is defined on the open end face of the strain relief member 10 and is limited by a portion of the second wall 88. The tab 92 is adapted to engage a corresponding recess 96 (FIG. 3) in the rear wall 34 of the shell 12. The recess 96 is located beneath the fastener 42. Thus, the location of the relief member 10 in the shell 12 can be at or near the location of the fastener 42. The rigidity of the relief member 10 serves to provide increased structural support to the hollow shell 12. More specifically, the relief member 10 provides structural support to the shell 12 at the general location of the fastener 42.

To assemble the respective components, the strain relief member 10 is slidably received within the shell 12 of the handle portion 4. With reference to FIG. 6, the tapered surfaces and edges of the shell 12 meet and engage the corresponding tapered surfaces and edges of the relief member 10 when the relief member 10 is at the desired location within the shell 12 (See also FIG. 8). More specifically, the relief member 10 fits snugly within the shell 12 at the desired location at or near the fastener 42 as a result of the mating tapered surfaces. Further, the tab 92 engages the recess 96 at this location to further secure the relief member 10 within the shell 12.

The cord 20 is positioned within the sinuous channel 70 of the relief member 10 prior to inserting the relief member 10 into the shell 12. Thus, the strain relief member 10 and the rear wall 34 of the shell 12 cooperate to trap the cord 20 therebetween. The path of the sinuous channel 70 forces the cord 20 to make a series of ninety degree bends as the cord 20 passes through the strain relief member 10.

If desired, the strain relief member 10 can be made from a suitable conventional thermoplastic material, as can the handle portion 4.

The resulting assembly of the strain relief member 10, the shell 12, and the cord 20 positioned in the strain relief member 10 and trapped between the shell 12 and the strain relief member 10 alleviates strain on the cord 20. Thus, a tension force applied to the cord 20 is less likely to disconnect the cord 20 from the switches 14,16 of the handle portion B. Such tension force would be applied first when securing the handle portion 4 on the housing 3. In one embodiment, such assembly is done by the consumer upon purchasing the vacuum cleaner from a mass merchant. In order to reduce the size of the container in which the vacuum cleaner is shipped, the handle, with its connected wiring is placed alongside the housing. When the consumer opens the container, he or she needs to secure the handle portion 4 to the housing 3 employing the bolt 58 and the housing and coverplate structure 54. Any strain on the electrical cords 24 and 26 during this process is alleviated by the strain relief member 10.

While the strain relief member has been illustrated as being positioned in the handle portion of an upright vacuum cleaner, it should be appreciated that a suitably configured strain relief member could also be positioned in some other part of the upright vacuum cleaner. Also, strain relief members can be employed in canister vacuum cleaners, hand held vacuum cleaners, carpet extractors, wet/dry vacuum cleaners and the like. Moreover, strain relief members can be employed with the power cord of any electrically powered appliance.

The invention has been described with reference to the preferred embodiment. Obviously, modifications and alterations will occur to others upon reading and understanding the preceding detailed description. It is intended that the invention be construed as including all such modifications and alterations insofar as they are within the scope of the appended claims or the equivalents thereof.

Having thus described the preferred embodiment, the invention is now claimed to be:

1. A handle arrangement for an ambulatory electrical machine comprising:
a housing adapted for movement on a surface;
a handle connected to the housing, the handle comprising a casing defining a cavity therein;
a switch mounted on the handle;
an electrical cord extending through the cavity and attached at one end to the switch; and
a strain relief member mounted in the cavity, the strain relief member comprising a sinuous channel defined therein for accommodating the electrical cord.

2. The handle arrangement of claim 1 wherein the strain relief member and an inner wall of the handle cavity cooperate to trap the electrical cord therebetween.

3. The handle arrangement of claim 1 wherein the strain relief sinuous channel comprises an approximately Ushaped cross-section.

4. The handle arrangement of claim 3 wherein the groove comprises a first section, a second section extending in a direction approximately normal to the first section, a third section offset and approximately parallel to the first section, and a fourth section extending in a direction approximately normal to the first and third sections.

5. The handle arrangement of claim 3 wherein the groove in the strain relief member is substantially of the same depth as a diameter of the electrical cord.

6. The handle arrangement of claim 1 wherein the handle casing is hollow and includes an opening for receiving the strain relief member.

7. The handle arrangement of claim 6 wherein the handle casing opening is located at one end of the handle casing.

8. The handle arrangement of claim 7 wherein an opposing end of the handle casing is closed off.

9. The handle arrangement of claim 1 wherein the strain relief member includes a tab which engages a recess defined in the handle casing to secure the strain relief member in the handle casing.

10. A vacuum cleaner comprising:
a housing section;
a nozzle section operatively connected to the housing section, the nozzle section including a main suction opening formed in an underside thereof;
an electrical switch positioned on one of the housing section and the nozzle section;
an electrical cord attached at one end to the switch;
a filter chamber defined in one of the housing section and the nozzle section for separating dust and dirt from a suction airstream;
a suction source located in one of the housing section and the nozzle section and being in fluid communication with the main suction opening; and
a strain relief member received in an opening of the one of the housing section and the nozzle section for minimizing strain on the electrical cord.

11. The vacuum cleaner of claim 10 wherein the strain relief member includes a sinuous channel that forces the electrical cord to make at least one approximately ninety degree bend relative to an axis of the electrical cord.

12. The vacuum cleaner of claim 11 wherein the sinuous channel is defined on one face of the strain relief member.

13. The vacuum cleaner of claim 10 wherein the strain relief member is slidably received within a portion of the one of the housing section as the nozzle section.

14. The vacuum cleaner of claim 10 wherein the strain relief member incudes a tab for engaging an opening on the one of the housing section and the nozzle section and positioning the strain relief member relative to the one of the housing section and the nozzle section.

15. A vacuum cleaner comprising:
a nozzle section;
a housing section connected to the nozzle section and in fluid communication with the nozzle section;
a filter chamber located in one of the housing section and the nozzle section for separating dirt and dust from a suction airstream;
a handle connected to the housing section, the handle comprising a casing and an opening defined within the casing;
a switch located on the handle casing;
an electrical cord connected at one end to the switch and running through the casing opening; and
a strain relief member positioned within the casing opening for alleviating strain on the electrical cord, the strain relief member comprising a sinuous channel through which the electrical cord extends.

16. The vacuum cleaner of claim 15 wherein the sinuous channel is defined in one face of the strain relief member.

17. The vacuum cleaner of claim 16 wherein the strain relief member one face cooperates with an inner wall surface of the handle casing opening to trap the electrical cord between the strain relief member and the handle.

18. The vacuum cleaner of claim 15 wherein the strain relief member includes a tab which cooperates with a recess defined in the handle to secure the strain relief member in the handle.

19. The vacuum cleaner of claim 15 wherein the casing opening is located at one end of the handle.

20. The vacuum cleaner of claim 15 wherein the strain relief member is slidably positioned within the handle case opening.
